(19) United States
(12) Patent Application Publication
(10) Pub. No.: US 2007/0230805 A1
(43) Pub. Date: Oct. 4, 2007

(54) Coded Data Recording Apparatus, Decoding Apparatus and Program

(76) Inventors: Yoshihisa Yamada, Tokyo (JP); Yoshiaki Kato, Tokyo (JP); Kohtaro Asai, Tokyo (JP)

Correspondence Address: BIRCH STEWART KOLASCH & BIRCH, PO BOX 747, FALLS CHURCH, VA, 22040-0747, US

(21) Appl. No.: 11/596,544

(22) PCT Filed: Jul. 27, 2004
(86) PCT No.: PCT/JP04/10665

§ 371 Date: Nov. 15, 2006

(51) Int. Cl. G06K 9/36

(52) U.S. Cl. 382/238

(57) ABSTRACT

A coded data recoding apparatus includes a coded data analyzing unit 1 for extracting block data and data showing the image characteristics of the block data from moving image coded data, two or more code tables 4 and 5 in each of which the code amount is optimized for each of the above-mentioned image characteristics, a code table selecting unit 2 for selecting a code table which is used for recoding on the basis of the data showing the image characteristics extracted by the coded data analyzing unit 1, and a variable length recoding unit 3 for outputting a bit stream of coded data in which the block data are recoded thereby using the code table selected by code table selecting unit 2 selected.

### FIELD OF THE INVENTION

The present invention relates to a coded data recoding apparatus which recodes moving image coded data, a decoding apparatus which decodes moving image coded data recoded by the coded data recoding apparatus, and programs which make a computer implement these apparatus, respectively.

### BACKGROUND OF THE INVENTION

In recent years, several types of coding methods have been proposed in order to reduce the amount of information of a moving image signal. These coding methods include some coding methods which have been established as international-standard methods. For example, ISO/IEC 13818-2 (MPEG-2) is a typical image coding method and is widely adopted in every country in the world as an image storage method for use with digital broadcasting and DVD media.

Recently, a study of a recoding method of recoding moving image coded data coded with this MPEG-2 without any loss in the moving image coded data has been also conducted. For example, patent reference 1 discloses such a recoding method. In accordance with the prior art method disclosed in this patent reference 1, a variable length code symbol among inputted coded data, which are defined by means of the coding method provided as a moving image compression reference, is set as a symbol to be recoded, and the frequency of occurrence of this symbol to be recoded is calculated for each predetermined frame. The symbol to be recoded included in the coded data is then recoded on the basis of the calculated occurrence frequency using either an arithmetic code or a variable length coding table which is regenerated on the basis of the calculated occurrence frequency.

In addition, in accordance with the prior art method disclosed in patent reference 1, the frequency of occurrence of the symbol to be recoded is calculated for each position of zigzag scanning which is calculated by decoding a two-dimensional variable length code symbol, or for each quantization step, and the moving image coded data is recoded on the basis of the calculated occurrence frequency.

[Patent reference 1] JP, 2001-346212, A

A problem with the prior art method as disclosed in patent reference 1 is that only determination of a variable length code is carried out on the basis of the frequencies of occurrence of symbols to be recoded, which is calculated for each zigzag scanning position or for each quantization step, and the code amount cannot be optimized and the recoding cannot be carried out more efficiently.

For example, in accordance with the prior art method, optimization cannot be carried out to prevent increase in the code amount according to the image characteristics for each subregion in the image which affect the probabilities of occurrence of the symbols. For example, in a case in which a flat region and a region having a complicated texture are included in a certain picture, efficient recoding in which the code amount is optimized according to the characteristics for each of these regions cannot be performed.

Furthermore, in the prior art, the sequence of the syntax of coded data cannot be recoded while being changed if needed. For this reason, even when a large bias occurs in the probabilities of occurrence of the symbols to be coded for each region in the image, for example, the bias cannot be used, and efficient recoding in which the code amount is optimized cannot be performed.

In addition, in the prior art, even though a flag which is not necessarily needed exists in the syntax of I pictures which are intra-frame coded pictures when carrying out decoding processing, for example, there is no means for removing this flag. For this reason, data which are not used for the decoding processing cannot be removed, and therefore the code amount cannot be optimized.

The present invention is made in order to solve the above-mentioned problems, and it is therefore an object of the present invention to provide a coded data recoding apparatus which optimizes the code amount and which can perform efficient recoding, a decoding apparatus which decodes coded data recoded by this coded data recoding apparatus suitably, and programs which make a computer implement these apparatus, respectively.

### DISCLOSURE OF THE INVENTION

In accordance with the present invention, there is provided a coded data recoding apparatus including: a coded data analyzing unit for accepting a bit stream of coded data on a moving image and analyzing the structure of the bit stream, and for extracting both coded data on a subregion in images which constructs the moving image and data showing the image characteristics of the subregion; a code table group provided with a plurality of code tables in which the code amounts of codes which are assigned to symbols to be coded in the subregion are optimized respectively for each of the image characteristics; a code table selecting unit for selecting a code table which is used for recoding of the coded data in the subregion from the code table group on the basis of the data showing the image characteristics extracted by the coded data analyzing unit; and a recoding unit for recoding the coded data in the subregion using the code table selected by the code table selecting unit, and for outputting a bit stream of coded data containing the data recoded thereby. Therefore, the present invention provides an advantage of being able to implement efficient recoding while optimizing the amount of codes.

In accordance with the present invention, there is provided a decoding apparatus including: a recoded data analyzing unit for accepting a bit stream of coded data on a moving image in which coded data on an image subregion which constructs the moving image are recoded by the above-mentioned coded data recoding apparatus, and analyzing the structure of the bit stream, and for extracting both recoded coded data on the subregion and data showing the image characteristics of the subregion; a code table group provided with a plurality of code tables in which the code amounts of codes which are assigned to symbols to be coded in the subregion are optimized respectively for each of the image characteristics; a code table selecting unit for selecting a code table which has been used for the recoding of the coded data in the subregion from the code table group on the basis of the data showing the image characteristics extracted by the recoded data analyzing unit; and a decoding processing unit for decoding the coded data in the subregion using the code table selected by the code table selecting unit, and for outputting a bit stream of original coded data. Therefore, the present invention provides an advantage of being able to reconstruct the original coded data from the coded data in which the symbols are changed for every region and are recoded.

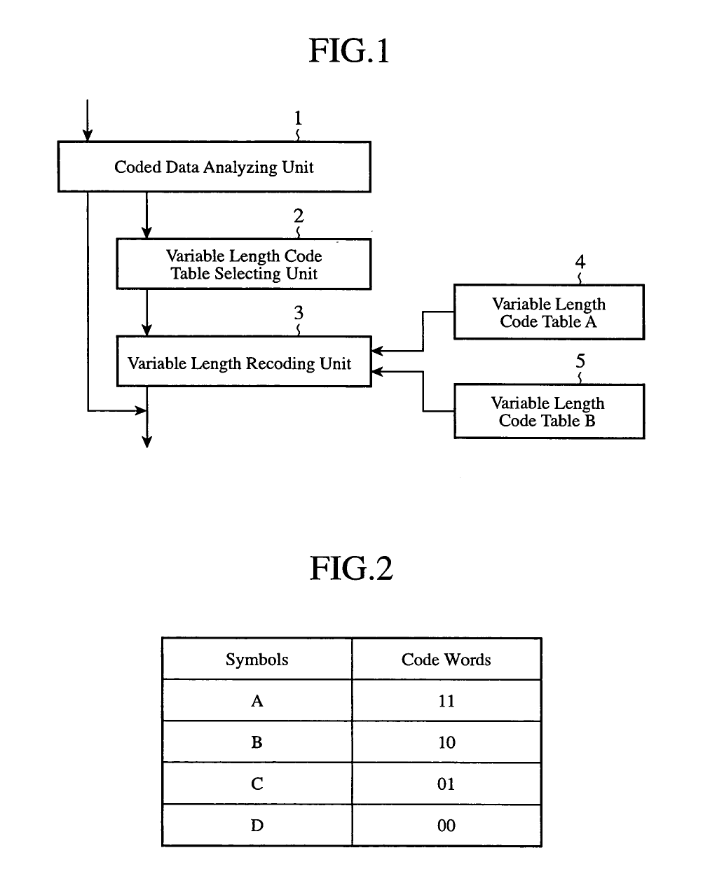

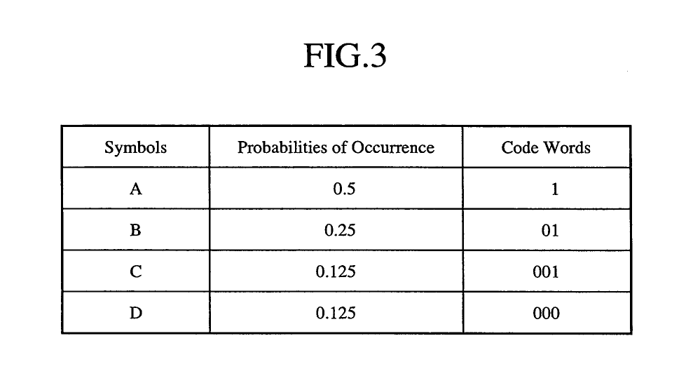

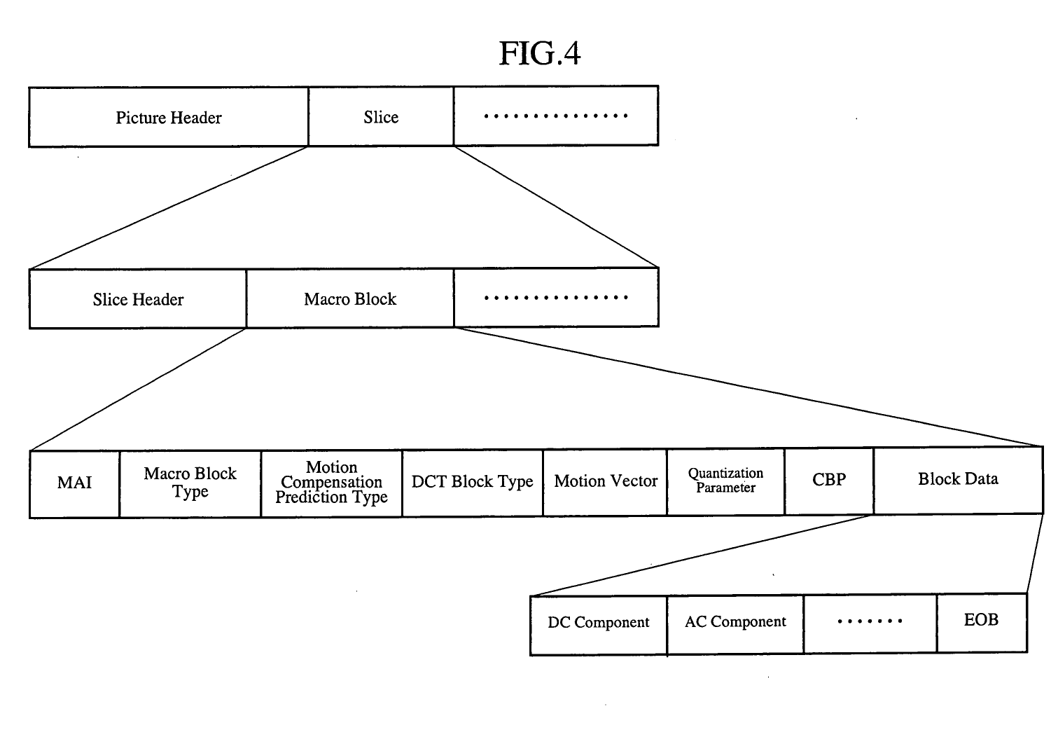

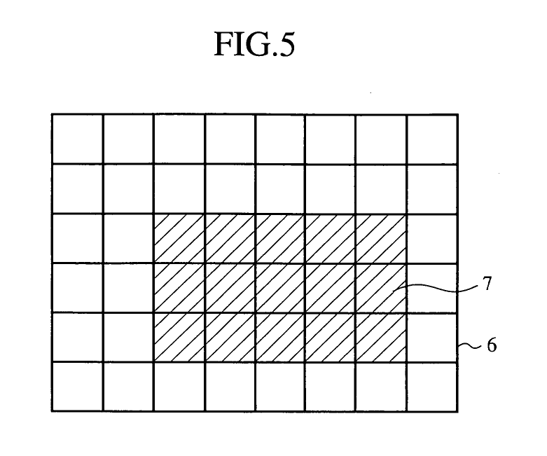

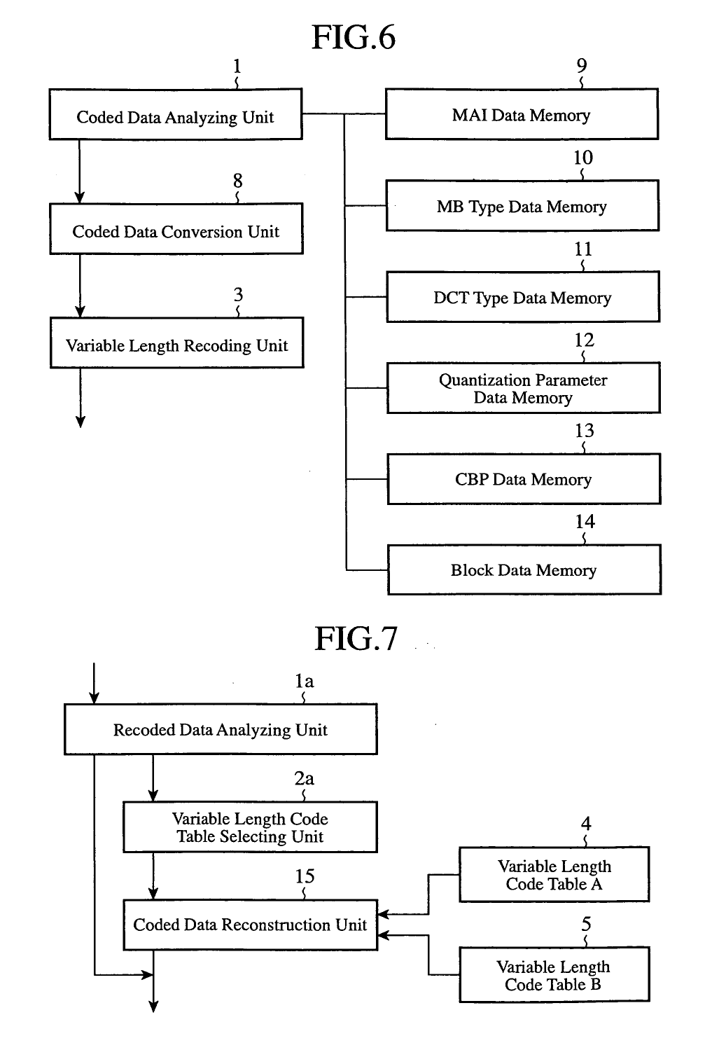

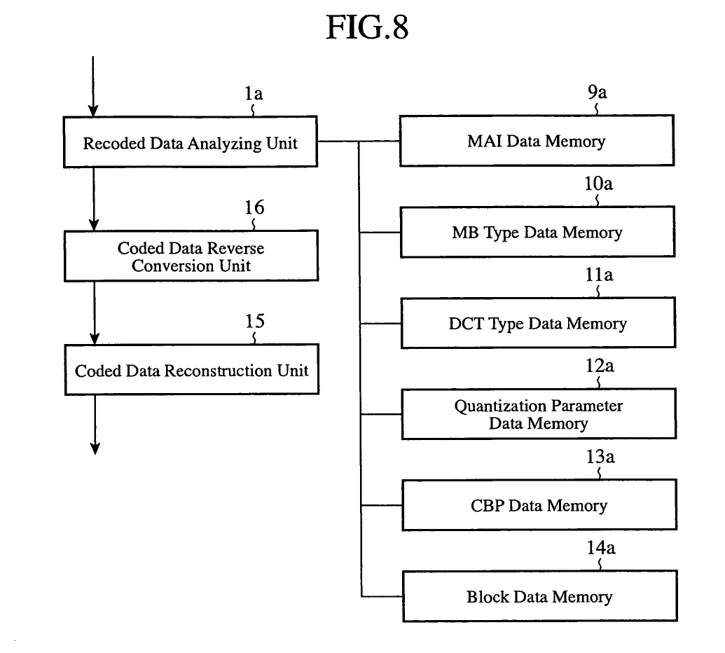

### BRIEF DESCRIPTION OF THE FIGURES

[FIG. 1] FIG. 1 is a block diagram showing the structure of a coded data recoding apparatus in accordance with embodiment 1 of the present invention;

[FIG. 2] FIG. 2 is a table showing a correspondence between symbols and equal-length code words which are assigned to the symbols, respectively;

[FIG. 3] FIG. 3 is a table showing a correspondence between symbols and variable length code words which are assigned to the symbols according to the probabilities of occurrence of them, respectively;

[FIG. 4] FIG. 4 is a diagram showing the outline of the syntax of MPEG-2;

[FIG. 5] FIG. 5 is a diagram for explaining a criterion for selecting one variable length code table from variable length code tables;

[FIG. 6] FIG. 6 is a block diagram showing the structure of a coded data recoding apparatus in accordance with embodiment 2 of the present invention;

[FIG. 7] FIG. 7 is a block diagram showing the structure of a decoding apparatus in accordance with embodiment 3 of the present invention; and

[FIG. 8] FIG. 8 is a block diagram showing the structure of a decoding apparatus in accordance with embodiment 4 of the present invention.

### PREFERRED EMBODIMENTS OF THE INVENTION

Hereafter, in order to explain this invention in greater detail, the preferred embodiments of the present invention will be described with reference to the accompanying drawings.

### Embodiment 1

FIG. 1 is a block diagram showing the structure of a coded data recoding apparatus in accordance with embodiment 1 of the present invention. The coded data recoding apparatus in accordance with this embodiment is provided with a coded data analyzing unit 1, a variable length code table selecting unit (i.e., a code table selecting unit) 2, a variable length recoding unit (i.e., a recoding unit) 3, and variable length code tables (i.e., a code table and a code table group) 4 and 5. The coded data analyzing unit 1 performs a decoding process on moving image coded data which comply with the standards of MPEG-2 so as to extract data to be recoded from the coded data.

The variable length code table selecting unit 2 selects a code table whose code amount is the smallest according to the data to be recoded from the plurality of variable length code tables. In the figure and the following explanation, the variable length code table selecting unit selects one of the two kinds of variable length code tables 4 and 5. The variable length recoding unit 3 recodes the moving image coded data using the variable length code table selected by the variable length code table selecting unit 2.

In the example shown in the figure, a case in which only the two kinds of tables are disposed as the plurality of variable length code tables which are used for the recoding is shown. The present invention is not limited to this example, and three or more kinds of tables can be disposed in the coded data recoding apparatus in accordance with this embodiment. For example, variable length code tables in which optimal code words are respectively assigned for data such as motion vector data and macro block data which will be mentioned below can be provided.

Next, assignment of code words to symbols to be coded will be explained. For example, a case in which code words are respectively assigned to four symbols (A, B, C, D) is considered. FIG. 2 is a table showing a correspondence between the symbols to be coded and equal-length code words which are respectively assigned to the symbols. Each code word shown in this figure which is assigned to one symbol always has a code length of two bits. This assignment of code words to the four symbols is optimal when the probability of occurrence of each of all the four symbols is equal to 0.25.

In contrast, in a case in which a bias in the probabilities of occurrence of the symbols is known in advance, the code length of each code word is varied according to the probability of occurrence of the corresponding symbol, and Huffman coding which reduces the whole code amount is used. FIG. 3 is a table showing a correspondence between the symbols to be coded and variable length code words which are assigned to the symbols according to the probabilities of occurrence of them, respectively.

The average code length per one symbol is given by (the probability-of-occurrence of the symbol A x the bit length of the code word assigned to the symbol A+the probability-of-occurrence of the symbol B×the bit length of the code word assigned to the symbol B+the probability-of-occurrence of the symbol C×the bit length of the code word assigned to the symbol C+the probability-of-occurrence of the symbol D×the bit length of the code word assigned to the symbol D). In the case of FIG. 3, the average code length per one symbol is 0.5×1+0.25×2+0.125×3+0.125×3=1.75 bits. In this case, the average code amount per one symbol can be reduced from that of each 2-bit equal-length code word shown in FIG. 2 by 0.25 bits.

In contrast, in the case in which the probabilities of occurrence of the four symbols are all equal to 0.25, the average code length at the time of using the code words shown in FIG. 3 is given by 0.25×1+0.25×2+0.25×3+0.25×3=2.25 bits. In this case, the average code amount per one symbol is increased from that of each 2-bit equal-length code word shown in FIG. 2 by 0.25 bits. Thus, it is necessary to assign an optimal code word to each symbol according to the probability of occurrence of each symbol in order to reduce the code amount and to carry out efficient recoding.

In addition, the coded data analyzing unit 1, variable length code table selecting unit 2, and variable length recoding unit 3 which are mentioned above can be embodied by executing a coded data recoding program in accordance with the present invention using, for example, a general-purpose computer.

An explanation of this embodiment will be made in more detail. The coded data recoding program in accordance with the present invention is loaded into a computer and the operation of the coded data recoding program is controlled so that the coded data analyzing unit 1, variable length code table selecting unit 2, and variable length recoding unit 3 shown in FIG. 1 can be implemented in the computer. In this case, the variable length code tables 4 and 5 can be formed in a storage unit of the computer.

Because the structure and fundamental functions of a computer which embodies the coded data recoding apparatus in accordance with the present invention can be recognized easily by those skilled in the art on the basis of the common general technical knowledge of the technical field of this invention, and are not directly in connection with the essence of the present invention, the detailed description of the structure and fundamental functions of a computer which embodies the coded data recoding apparatus in accordance with the present invention will be omitted in the following explanation.

FIG. 4 is a diagram showing the outline of the syntax of MPEG-2. In the following explanation, the coded data analyzing unit 1 operates according to the MPEG-2 standards. In MPEG-2, a video signal is formed hierarchically so that elements arranged hierarchically are handled. For example, picture data as shown in FIG. 4 consists of one picture header and two or more slice data. Each slice data consists of one slice header and two or more macro block data.

Each macro block consists of four luminance-signal blocks and two kinds of color-difference-signal blocks. Furthermore, each macro block data consists of six block data on luminance-signal blocks and color-difference-signal blocks, and information on some macro blocks.

Thus, coded data based on MPEG-2 consists of header information, such as a picture header and a slice header, MAI (Macroblock Address Increment) showing position information on each macro block, macro block mode information, and macro block information, which are information on each macro block, and six block data on each macro block.

The macro block mode information is information on each macro block including three kinds of information: a macro block type, a motion compensation prediction type, and a DCT (Discrete Cosine Transform) block type. The macro block information is information provided for each macro block, such as motion vector data, a quantization parameter (quantization width characteristics), and CBP (Coded Block Pattern) which is a significant block pattern.

Next, the operation of the coded data recoding apparatus in accordance with this embodiment of the present invention will be explained.

In this embodiment 1, for the sake of simplicity, a case in which only block data is set as a target to be recoded will be explained as an example.

First, the coded data analyzing unit 1 performs a decoding process in accordance with the standards of MPEG-2 on coded data inputted as a bit stream, analyzes the structure of the bit stream, and determines the output destination of the bit stream according to the constitution data of the bit stream.

To be more specific, the coded data analyzing unit outputs, as an output of the apparatus, data which is the one other than the block data to be recoded and which is not used for recoding which will be mentioned below, just as it is, as shown by an arrow connected to an arrow showing the output of the variable length recoding unit 3 shown in the figure. In contrast, the coded data analyzing unit outputs both the block data included in the inputted coded data and specific data (e.g., motion vector data provided for each macro block), which the variable length code table selecting unit 2 mentioned below uses to select a table, to the variable length code table selecting unit 2.

The block data includes a transform coefficient which is acquired by performing a two-dimensional DCT on the video signal of each block (i.e., a differential signal between the input signal to be coded and a prediction reference signal which has been coded in the case of a P picture or a B picture), and which is then quantized, and is information showing the texture of each block. For this reason, when two or more objects to be shot are seen in the moving image, there is a tendency that the frequencies of occurrence of different symbols in block data on identical objects to be shot are relatively uniform, whereas the frequencies of occurrence of different symbols in block data on different objects to be shot are not uniform.

Therefore, when carrying out recoding of the above-mentioned block data, the variable length code table selecting unit 2 changes the assignment of the variable length code table 4 or 5 which is used for the recoding for each object to be shot in the above-mentioned block data. Concretely, the variable length code table selecting unit 2 executes the following first to fifth selection processes, for example, so as to switch between the variable length code tables.

In the first selection process, a threshold about the size of a moving vector provided for each macro block is set to the variable length code table selecting unit 2 in advance. When accepting the block data to be recoded (i.e., coded data on a subregion in images which construct the moving image) and a moving vector provided for each macro block from the coded data analyzing unit 1, the variable length code table selecting unit 2 selects one table from the variable length code tables 4 and 5 for the recoding according to a result of comparison between the moving vector and the above-mentioned threshold.

The above-mentioned selection process will be explained by giving a concrete example of the process. In the case of a P picture or a B picture on which a motion compensation prediction is performed, a transform coefficient which is acquired by performing a two-dimensional DCT on a differential signal between the input signal to be coded and a prediction reference signal which has been coded, and which is then quantized constructs block data. In a region where variations among images which are sequentially running with respect to time and which construct the moving image are small, because the differential signal becomes small, the symbol (i.e., the quantized transform coefficient) of block data having a probability of occurrence which is deviated toward a small value close to 0 and a small motion vector become a target to be coded.

In contrast, in a region where variations among images which are sequentially running with respect to time and which construct the moving image are large, the symbol of block data having a probability of occurrence which is not biased largely and a large motion vector become a target to be coded. The size of the motion vector represents an image characteristic indicating variations in the image signal among macro block regions of images which are sequentially running with respect to time and which construct the moving image.

Therefore, the above-mentioned threshold is determined so that the code amount exhibits an increase which falls within an allowable range even if an equal-length code word is assigned to each symbol. The variable length code table selecting unit then determines that an image region of macro blocks specified by the sizes of motion vectors equal to or larger than this threshold has image characteristics in which motion vectors are large and the bias in the probabilities of occurrence of the symbols to be coded of block data is small, and selects a code table for assigning equal-length code words to the symbols, respectively, as shown in FIG. 2.

In contrast, the variable length code table selecting unit determines that an image region of macro blocks specified by the sizes of motion vectors smaller than the above-mentioned threshold has image characteristics in which motion vectors are small and the probabilities of occurrence of the symbols to be coded of block data are deviated toward a small value close to 0. In this case, the assignment of an equal-length code word to each symbol would increase the code amount on the contrary, as mentioned above. Therefore, the variable length code table selecting unit selects, as a code table corresponding to motion vector having sizes smaller than the threshold, a code table for assigning a variable length code word whose code amount is minimized according to the bias in the probabilities of occurrence of the symbols as shown in FIG. 3.

Two or more thresholds about motion vectors are set up, each block data is divided into three or more parts according to the size of the motion vector, and code tables corresponding to the image characteristics specified by the sizes of motion vectors which are grouped according to the thresholds are prepared in advance. Even in this case, when the recoding of each block data which is grouped according to the two or more thresholds is carried out, the variable length code table selecting unit can select an appropriate code table.

Furthermore, the variable length code table selecting unit 2 is so constructed as to change the threshold about motion vectors dynamically, and to have code tables which are prepared for ranges having sizes which are varied with change in the threshold, respectively. For example, the variable length code table selecting unit estimates the intensity of motion in each scene in the coded moving image from the distribution of motion vectors in an already coded picture, and reduces the threshold when a scene having large intensity of motion is continuing.

In this case, the preparation of a code table for assigning an equal-length code word to each symbol, as shown in FIG. 2, for motion vectors having a size equal to or larger than the thresholds makes it easy for the code table to be selected with a change in the thresholds at the time when a scene having large intensity of motion is continuing. The preparation also makes it possible for the apparatus to flexibly respond to time-varying variations in the image signal characteristics of the subregion in images which construct the moving image.

The variable length coding section 3 carries out recoding of the block data which constructs the above-mentioned macro block using the variable length code table which is selected by the variable length code table selecting unit 2 for the above-mentioned macro block as mentioned above. In this case, the selection of the variable length code table is uniquely done according to the size of the motion vector.

When the recoded moving image coded data is decoded, the size of the motion vector can be acquired from the motion vector data shown in FIG. 4, and the code table used for the recoding can be specified. For this reason, it is not necessary to add information specifying which code table has been selected for the recoding to the recoded moving image coded data.

In the second selection process, a threshold about the number of symbols in the block data to be recoded is set to the variable length code table selecting unit 2 in advance. The coded data analyzing unit 1 analyzes the accepted coded data to acquire the block data and the number of symbols in the block data, and outputs them to the variable length code table selecting unit 2.

The variable length code table selecting unit 2 selects one table from the variable length code tables 4 and 5 for the recoding according to a result of comparison between the number of symbols and the above-mentioned threshold.

The number of symbols in the block data is not set up by the syntax of the moving image coded data, as shown in FIG. 4. In other words, when decoding the recoded moving image coded data, the apparatus cannot specify the code table which has been used for the recoding from the moving image coded data.

The variable length recoding unit 3 then adds information for specifying the code table selected upon the recoding to the recoded moving image coded data. As a method of adding the information specifying the code table selected upon the recoding to the recoded moving image coded data, a method of adding the information specifying the selected code table, as a part of the picture header, slice header, macro block mode information, or the like in the recoded moving image coded data, to the recoded moving image coded data can be provided.

Only one or more symbols are generally included in the block data in a flat region on the screen, whereas many symbols are included in the block data in a region having a complicated texture. The frequency of occurrence of the symbols to be coded also differs according to the number of symbols included in the block data.

For this reason, by selecting an appropriate variable length code table according to the number of times of occurrence of the symbols, the recoding processing can be carried out efficiently. Thus, the number of the symbols can serve as an index for getting to know the image characteristics, such as whether a subregion specified by each block data in the image is flat or has a complicated texture.

In the third selection process, a threshold about the value of the DC component of the DCT coefficient in the block data to be recoded is set to the variable length code table selecting unit 2 in advance. The coded data analyzing unit 1 then analyzes the accepted coded data to acquire the block data and the DC component of the block data, and outputs them to the variable length code table selecting unit 2.

The variable length code table selecting unit 2 selects one table from the variable length code tables 4 and 5 for the recoding according to a result of comparison between the difference between the DC component of the region specified by the block data to be recoded and the DC component of another region surrounding the region, and the above-mentioned threshold.

The variable length recoding unit 3 performs the recoding process on the block data using the variable length code table which is selected by the variable length code table selecting unit 2 as mentioned above. In the MPEG-2 standards, the process of coding the DC component of the block data differs from the process of coding the AC component.

That is, when decoding the recoded moving image coded data, the DC component value is extracted from the moving image coded data, and the process of selecting a variable length code table is determined uniquely. For this reason, it is not necessary to add any information indicating which code table has been selected to the recoded moving image coded data.

In many cases, regions having the same DC component value in the image are in conditions having the same brightness and the same color. For this reason, the value of the DC component of a subregion indicating a brightness condition and a color condition can serve as an index showing the image characteristics of the subregion in the image.

In the fourth selection process, the variable length code table selecting unit 2 calculates the code amount which actually occurs using all of or two or more of the plurality of variable length code tables one of which can be selected for the recoding, and selects a variable length code table having the smallest code amount. In this case, because the apparatus needs to carry out the variable length coding processing once, the throughput of the recoding increases, but the variable length code table selecting unit can select a variable length code table having the highest degree of coding efficiency.

In this selection process, the variable length code table selecting unit 2 selects a code table on the basis of the code amount which actually occurs. For this reason, when the recoded moving image coded data is decoded, the variable length code table selected upon the recoding cannot be specified from the moving image coded data.

Therefore, the variable length code table selecting unit 2 separately adds the information for specifying the code table selected upon the recoding to the recoded moving image coded data, as in the case of the second selection process.

In the fifth selection process, the coded data analyzing unit 1 measures the frequencies of occurrence of the symbols in the block data. According to the pattern of the frequencies of occurrence of the plurality of symbols, a plurality of code tables which respectively provide optimal code amounts are prepared in advance.

The variable length code table selecting unit 2 accepts the frequencies of occurrence of the symbols in the block data one after another from the coded data analyzing unit 1, and then determines whether the pattern of the frequencies of occurrence of the symbols is suited to a variable length code table currently being selected.

For example, a relation between possible patterns of the frequencies of occurrence of the symbols and code tables which respectively provide optimal code amounts are predetermined through actual coding processing, and code tables are provided according to this relation. Each possible pattern of the frequencies of occurrence of the symbols is registered into the variable length code table selecting unit 2 while being associated with a code table.

The variable length code table selecting unit 2 then compares a pattern of the frequencies of occurrence of the symbols corresponding to the variable length code table currently being selected with the pattern of the frequencies of occurrence of the symbols inputted thereto from the coded data analyzing unit 1 so as to determine whether the pattern of the frequencies of occurrence of the symbols inputted thereto from the coded data analyzing unit 1 is suited to the variable length code table currently being selected.

When then determining that the pattern of the frequencies of occurrence of the symbols inputted thereto from the coded data analyzing unit 1 is suited to the variable length code table currently being selected, the variable length code table selecting unit 2 selects the variable length code table currently being selected for the recoding, just as it is.

In contrast, when determining that the pattern of the frequencies of occurrence of the symbols inputted thereto from the coded data analyzing unit 1 does is not suited to the variable length code table currently being selected, the variable length code table selecting unit 2 determines an optimal variable length code table on the basis of the result of the comparison between the pattern of the frequencies of occurrence of the symbols inputted thereto from the coded data analyzing unit 1 and all the possible patterns of the frequencies of occurrence of the symbols which have been registered in advance, and changes the selection to the determined code table.

For example, assume a case in which the frequencies of occurrence of the code word symbols of the block data inputted from the coded data analyzing unit 1 have a bias, such as a higher frequency of occurrence of small symbols like ±1 and ±2, which are recognized in the subregion specified by the block data.

In this case, the variable length code table selecting unit 2 selects a code table, as shown in FIG. 3, which uses variable length code words according to the probabilities of occurrence of the symbols. In contrast, if the frequencies of occurrence of the code word symbols of the block data inputted from the coded data analyzing unit have a pattern in which every symbol occurs at much the same frequency, the variable length code table selecting unit 2 selects a code table, as shown in FIG. 2, which uses equal-length code words.

When the recoded moving image coded data are decoded, the frequencies of occurrence of symbols of each block data are read from each block data of the recoded moving image coded data, and the process of selecting a variable length code table is determined uniquely. For this reason, it is unnecessary to add the information indicating which code table has been selected to the recoded moving image coded data.

In the example mentioned above, the case in which the process of selecting a variable length code table is carried out on a block-by-block basis is explained. As an alternative, the data showing the image characteristics as mentioned above can be extracted on a macro-block-by-macro-block basis or on a slice-by-slice basis, and the selecting process can be carried out.

In the case in which the information specifying which code table has been selected is separately added to the recoded moving image coded data, a flag for identifying the selected code table can be provided on a block-by-block basis, on a macro-block-by-macro-block basis, or on a slice-by-slice basis.

In addition, as the information specifying which code table has been selected upon the recoding, the following information can be adopted, for example. FIG. 5 is a diagram for explaining a criterion for selecting one variable length code table, and shows a single screen on which coded data to be recoded are displayed. As shown in the figure, the screen 6 is divided into a plurality of rectangular areas, and the data showing the image characteristics are extracted from image data about a region 7 which consists of a plurality of hatched rectangular areas which are included in the screen 6.

A case in which the process of selecting a variable length code table is carried out using the data showing the image characteristics is considered. In this case, a variable length code table which is uniquely selected from the position of the region 7 can be determined. Therefore, only position information on the position of the rectangular area at the upper left or lower right corner which constructs the region 7 can be adopted as the information specifying the code table.

Even in the case in which the information specifying the selected code table is unnecessary, as in the cases of the first, third, and fifth selection processes, the information specifying the code table can be separately added to the recoded moving image coded data.

As mentioned above, the coded data recoding apparatus in accordance with embodiment 1 is provided with the coded data analyzing unit 1 for accepting a bit stream of coded data on a moving image and analyzing the structure of the bit stream, and for extracting both coded data and data showing image characteristics; the variable length code tables 4 and 5 in which code amounts of codes which are assigned to symbols to be coded in the block data are optimized respectively for each of the image characteristics; the code table selecting unit 2 for selecting a variable length code table which is used for recoding on the basis of the data showing the image characteristics extracted by the coded data analyzing unit 1; and the variable length recoding unit 3 for recoding the block data using the variable length code table selected by the code table selecting unit 2, and for outputting a bit stream of coded data containing the block data recoded thereby. Therefore, by defining block data which are coded data on a subregion in images which construct the moving image, and which occupies most of the moving image coded data as a target to be recoded, the coded data recoding apparatus can select a variable length code table according to the signal characteristics of the subregion in images. As a result, the coded data recoding apparatus can carry out recoding of the moving image coded data efficiently. For example, the coded data recoding apparatus carry out recoding of coded data which comply with the MPEG-2 standards efficiently according to the characteristics of each region in each picture.

In above-mentioned embodiment 1, the first through fifth selection processes are explained separately. As an alternative, the coded data recoding apparatus can carry out the first through fifth selection processes one after another so as to select a variable length code table.

### Embodiment 2

In above-mentioned embodiment 1, an example in which the coded data recoding apparatus defines block data in moving image coded data as a target to be coded, and then recodes the block data is explained. In contrast, a coded data recoding apparatus in accordance with this embodiment 2 defines constitution data of slice headers or macro blocks in moving image coded data as a target to be coded, and then recodes the constitution data.

FIG. 6 is a block diagram showing the structure of the recoding apparatus for recoding moving image coded data in accordance with embodiment 2 of the present invention. The recoding apparatus in accordance with this embodiment 2 is provided with a coded data analyzing unit 1, a variable length recoding unit 3, a coded data conversion unit 8, an MAI data memory 9, an MB type data memory 10, a DCT type data memory 11, a quantization parameter data memory 12, a CBP data memory 13, and a block data memory 14.

The coded data analyzing unit 1 carries out a process of decoding the moving image coded data according to the standards of MPEG-2 so as to extract data to be recoded from the coded data. The variable length recoding unit 3 recodes the moving image coded data to be recoded inputted thereto from the coded data conversion unit 8.

The variable length recoding unit 3 in accordance with this embodiment 2 carries out an algebraic coding process, instead of using a variable length code table, unlike that of above-mentioned embodiment 1. The coded data conversion unit 8 performs a conversion process, such as a deletion process of deleting symbols and a conversion process of replacing a symbol with another symbol, on the moving image coded data to be recoded.

The MAI data memory 9 stores MAI data. The MB type data memory 10 stores macro block type data. The DCT typed at a memory 11 stores DCT block type data. The quantization parameter data memory 12 stores quantization parameter data. The CBP data memory 13 stores CBP data. The block data memory 14 stores block data.

The coded data analyzing unit 1, coded data conversion unit 8, and variable length recoding unit 3 which are mentioned above can be embodied by executing a coded data recoding program in accordance with the present invention using, for example, a general-purpose computer.

An explanation of this embodiment will be made in more detail. The coded data recoding program in accordance with the present invention is loaded into a computer and the operation of the coded data recoding program is controlled so that the coded data analyzing unit 1, coded data conversion unit 8, and variable length recoding unit 3 shown in FIG. 6 can be implemented in the computer. In this case, the memories 9 to 14 can be formed in a storage unit of the computer.

Because the structure and fundamental functions of a computer which embodies the coded data recoding apparatus in accordance with the present invention can be recognized easily by those skilled in the art on the basis of the common general technical knowledge of the technical field of this invention, and are not directly in connection with the essence of the present invention, the detailed description of the structure and fundamental functions of a computer which embodies the coded data recoding apparatus in accordance with the present invention will be omitted in the following explanation.

Next, the operation of the recoding apparatus in accordance with this embodiment of the present invention will be explained.

First, the coded data analyzing unit 1 performs a decoding process in accordance with the standards of MPEG-2 on coded data inputted thereto as a bit stream, analyzes the structure of the bit stream, and outputs coded data to be recoded which are extracted from the bit stream to the coded data conversion unit 8. In this case, after storing the coded data to be converted in the corresponding memories 9 to 14 properly, the coded data analyzing unit 1 outputs them to the coded data conversion unit 8 in order to enable the coded data conversion unit 8 to perform the conversion process on the coded data to be converted.

The coded data conversion unit 8 deletes data which are not needed when decoding the inputted coded data to generate original coded data according to the MPEG standards after carrying out recoding of the coded data to be decoded from the constitution data of the moving image coded data inputted from the coded data analyzing unit 1, or replaces the data which are not needed when decoding the inputted coded data with data having a small amount of information. Concretely, the coded data conversion unit carries out the following first to third conversion processes, for example.

First, in the first conversion process, the coded data conversion unit 8 deletes slice headers from the constitution data of the moving image coded data to be recoded which are inputted from the coded data analyzing unit 1.

Originally, slice headers in MPEG are set up in order to restore coded data from an error situation when an error occurs in the coded data. For this reason, in applications which do not need to assume occurrence of errors, as in the case of reproducing moving image coded data from a storage medium, slice headers are unnecessary. Therefore, the coded data conversion unit 8 deletes slice headers from the constitution data of the moving image coded data to be recoded. As a result, in each slice of the coded data, a macro block is placed at the position of each slice header, and the sequence of the syntax is changed.

In the second conversion process, in a case in which a picture to be recoded of the moving image coded data inputted from the coded data analyzing unit 1 is an I picture, the coded data conversion unit 8 deletes the MAI data of each macro block. In the case of an I picture on which only an intra-frame coding process is performed, the MAI data always have a value of “1.”

Such data having the same value at all times can be uniquely processed when a reconstructing process is performed on coded data which have been recoded. Therefore, in a case in which the picture to be recoded is an I picture, the coded data conversion unit 8 deletes the MAI data in each macro block. As a result, in each macro block of the coded data, macro block type data is placed at the position of the MAI data, and the sequence of the syntax is changed.

In contrast, in a case in which the picture to be recoded has such a picture type as a P or B picture type, the MAI data of each macro block can have a value other than “1.” In general, the value of the MAI data corresponds to existence of motion in the screen and the state of the texture. In other words, in a P picture or a B picture, the distribution of the value of the MAI data tends to have a bias in the screen.

Therefore, in the case in which the picture to be recoded has such a picture type as a P or B picture type, the following processing is carried out using the characteristics of the algebraic coding in which the compression rate increases with increase in the degree of the bias in the distribution of occurrence of the symbols to be coded.

First, when determining that the picture to be recoded has such a picture type as a P or B picture type through analysis of the inputted moving image coded data to be recoded, the coded data analyzing unit 1 extracts only the MAI data from the coded data, and stores the extracted MAI data in the MAI data memory 9 one after another so that MAI data of one screen are stored in the MAI data memory.

The variable length recoding unit 3 collectively reads the MAI data of one screen which have been stored one after another from the MAI data memory 9 via the coded data analyzing unit 1 and coded data conversion unit 8, and recodes the MAI data through algebraic coding.

As mentioned above, because the variable length recoding unit collectively defines only one screen's MAI data having a tendency that the distribution of occurrence of the MAI data has a bias in the screen as a target to be coded, it can algebraic-code the MAI data by raising the degree of the bias in the distribution of occurrence of the MAI data in the screen. As a result, by making the most of the bias in the distribution of occurrence of the MAI data in one screen, efficient recoding can be implemented.

In the third conversion process, in the case in which the picture to be recoded of the moving image coded data inputted from the coded data analyzing unit 1 is an I picture, the coded data conversion unit 8 replaces a symbol of “01” of the symbols in the macro block type data with a symbol of “0” having a smaller amount of information.

In the case of an I picture on which only an intra-frame coding process is performed, the macro block type data always have only a symbol of “1” or “01.” This is because consistency with the decoding process performed on other picture types (i.e., the P picture and B picture types) is provided.

In this case, assuming only an I picture, even two symbols: “1” and “0” can be decoded uniquely. Therefore, in the case in which the picture to be recoded is an I picture, the coded data conversion unit 8 replaces the symbol “01” of the symbols in the macro block type data with the symbol of “0.”

The distribution of macro block type data has a tendency that it has a bias in the screen, like that of MAI data as explained in the case of the second conversion process. Therefore, in the case in which the picture to be recoded has such a picture type as a P or B picture type, the coded data analyzing unit 1 extracts only the macro block type data and stores it in the MB type data memory 10 one after another so that one screen's macro block type data are stored in the MB type data memory.

The variable length recoding unit 3 collectively reads the one screen's macro block type data which are stored one after another from the MB type data memory 10 via the coded data analyzing unit 1 and coded data conversion unit 8, and recodes the one screen's macro block type data through algebraic coding.

As mentioned above, because the variable length recoding unit collectively defines only one screen's macro block type data having a tendency that the distribution of occurrence of the macro block type data has a bias in the screen as a target to be coded, it can algebraic-code the macro block type data by raising the degree of the bias in the distribution of occurrence of the macro block type data in the screen. As a result, by making the most of the bias in the distribution of occurrence of the macro block type data in one screen, efficient recoding can be implemented.

The coded data conversion unit carries out the recoding processing by making the most of the bias in the distribution of occurrence of the target to be coded using the data memories 11 to 14 in addition to the data conversion processes mentioned above.

For example, DCT block type data are not based on the picture type of the moving image coded data, but always have a symbol of “1” or “0.” This DCT-blocks type data, as well as MAI data and macro block type data, has a tendency that the distribution of occurrence thereof has a bias in the screen.

Therefore, the coded data analyzing unit 1 extracts only the DCT block type data in the coded data through analysis of the inputted moving image coded data to be recoded, and stores the extracted DCT block type data one after another in the DCT type data memory 11 so that one screen's DCT block type data are stored in the DCT type data memory.

The variable length recoding unit 3 collectively reads the one screen's DCT block type data which are stored one after another from the DCT block type data memory 11 via the coded data analyzing unit 1 and coded data conversion unit 8, and recodes the one screen's DCT block type data through algebraic coding.

As mentioned above, because the variable length recoding unit collectively defines only one screen's DCT block type data having a tendency that the distribution of occurrence of the DCT block type data has a bias in the screen as a target to be coded, it can algebraic-code the DCT block type data by raising the degree of the bias in the distribution of occurrence of the DCT block type data in the screen. As a result, by making the most of the bias in the distribution of occurrence of the DCT block type data in one screen, efficient recoding can be implemented.

Similarly, the coded data analyzing unit 1 can also store quantization parameter data and CBP data one after another in the quantization parameter data memory 12 and CBP data memory 13, respectively, so that one screen's quantization parameter data and CBP data are stored in the quantization parameter data memory and CBP data memory, respectively, and the variable length recoding unit 3 can collectively recode the quantization parameter data and CBP data, respectively.

The coded data analyzing unit can further store all the macro block type data by also using the block data memory 14 so that one screen's all the macro block type data are stored in the block data memory, and can recode all the macro block type data collectively.

In other words, the coded data analyzing unit 1 extracts the MAI data, macro block type data, DCT block type data, quantization parameter data, CBP data, and block data in each macro block, respectively, through analysis of the inputted moving image coded data to be recoded, and stores them one after another in the data memories 9 to 14, respectively, so that all the data of one screen are stored in the data memories, respectively.

The variable length recoding unit 3 collectively reads all the data of one screen which are stored one after another from the data memories 9 to 14 via the coded data analyzing unit 1 and coded data conversion unit 8, respectively, and recodes them through algebraic coding, respectively.

In the processing mentioned above, the example in which one screen s data to be coded are stored in either of the memories 9 to 14 corresponding to the data to be coded is shown. In a case in which the first conversion process is not used together, that is, in a case in which slice headers are not deleted, data to be recoded can be collectively recoded in units of slices.

In addition, the variable length recoding unit can read and recode data stored in the memories 9 to 14 in units of regions in the screen in combination with the structure in accordance with above-mentioned embodiment 1.

For example, the variable length code table selecting unit 2 in accordance with above-mentioned embodiment 1 is disposed between the coded data conversion unit 8 in accordance with this embodiment 2 shown in FIG. 6 and the variable length recoding unit 3, and the variable length recoding unit 3 is provided with a plurality of variable length code tables.

In this structure, the coded data analyzing unit 1 extracts, for example, all block data and their motion vectors in each macro block through analysis of the inputted moving image coded data to be recoded, and stores them one after another in the block data memory 14 so that all the block data and motion vectors of one screen can be stored in the block data memory.

When receiving all the block data of one screen and motion vectors provided to the macro block from the block data memory 14 via the coded data analyzing unit 1, the variable length code table selecting unit 2 selects a variable length code table for each block data according to a result of comparison between the motion vector and a threshold. The variable length recoding unit 3 recodes all the block data of one screen using the variable length code table selected by the variable length code table selecting unit 2, respectively.

As mentioned above, the coded data recoding apparatus in accordance with embodiment 2 is provided with the coded data analyzing unit 1 for accepting a bit stream of coded data on a moving image and analyzing the structure of the bit stream, and for extracting constitution data of the coded data from the bit stream; the plurality of memories 9 to 14 for storing the constitution data of the coded data extracted by the coded data analyzing unit 1, respectively; the coded data conversion unit 8 for performing a process of deleting data which are not used for a decoding process to be performed on the constitution data of the coded data and/or a process of replacing a symbol to be coded of the constitution data of the coded data with digital data having a smaller amount of information on the constitution data of the coded data; and the variable length recoding unit 3 for reading the constitution data of the coded data from the plurality of memories 9 to 14, respectively, so as to recode the data to be recoded, and for outputting a bit stream of coded data containing the data recoded thereby. Therefore, the coded data recoding apparatus can delete unnecessary data included in the coded data which comply with the MPEG-2 standards at the time of decoding them, or convert redundant symbols into data having a smaller amount of information, and therefore can recode the data to be recoded efficiently by coding various symbols collectively.

### Embodiment 3

FIG. 7 is a block diagram showing the structure of a decoding apparatus in accordance with embodiment 3 of the present invention, and shows a case in which it decodes moving image coded data in which block data have been recoded. The decoding apparatus in accordance with this embodiment is provided with a recoded data analyzing unit 1a, a variable length code table selecting unit 2a, a coded data reconstruction unit 15, and variable length code tables 4 and 5.

The recoded data analyzing unit 1a analyzes moving image coded data which have been recoded by, for example, the coded data recoding apparatus in accordance with above-mentioned embodiment 1, and extracts recoded data to be decoded from the coded data. The variable length code table selecting unit 2a selects a code table which has been used for the recoding from a plurality of variable length code tables on the basis of the data to be decoded inputted from the recoded data analyzing unit 1a.

In the figure and the following explanation, assume that the coded data to be decoded have been recoded using either one of the two kinds of variable length code tables 4 and 5. As an alternative, three or more kinds of variable length code tables can be provided. The coded data reconstruction unit 15 decodes the moving image coded data which comply with the standards of MPEG-2 using the variable length code table selected by the variable length code table selecting unit 2a.

In addition, the recoded data analyzing unit 1a, variable length code table selecting unit 2a, and coded data reconstruction unit 15 can be embodied by executing a decoding processing program in accordance with the present invention using, for example, a general-purpose computer.

An explanation of this embodiment will be made in more detail. The decoding processing program in accordance with the present invention is loaded into a computer and the operation of the decoding processing program is controlled so that the recoded data analyzing unit 1a, variable length code table selecting unit 2a, and coded data reconstruction unit 15 shown in FIG. 7 can be implemented in the computer. In this case, the variable length code tables 4 and 5 can be formed in a storage unit of the computer.

Because the structure and fundamental functions of a computer which embodies the decoding apparatus in accordance with the present invention can be recognized easily by those skilled in the art on the basis of the common general technical knowledge of the technical field of this invention, and are not directly in connection with the essence of the present invention, the detailed description of the structure and fundamental functions of a computer which embodies the decoding apparatus in accordance with the present invention will be omitted in the following explanation.

Next, the operation of the decoding apparatus in accordance with this embodiment of the present invention will be explained.

In this embodiment 3, for the sake of simplicity, a case in which block data have been recoded and are decoded will be explained as an example.

First, the recoded data analyzing unit la accepts moving image coded data in which the block data have been recoded by the recoding apparatus in accordance with above-mentioned embodiment 1, performs a decoding process which complies with the standards of MPEG-2 on the inputted coded data so as to analyze the structure of the coded data, and determines an output destination according to the constitution data of the coded data.

To be more specific, the recoded data analyzing unit outputs, as an output of the apparatus, data which is the one other than the recoded block data and which is not used for decoding which will be mentioned below, just as it is, as shown by an arrow connected to an arrow showing the output of the coded data reconstruction unit 15 shown in the figure.

In contrast, the recoded data analyzing unit outputs both the recoded block data included in the inputted coded data and specific data (e.g., motion vector data provided to each macro block), which the variable length code table selecting unit 2a mentioned below uses to select a table, to the variable length code table selecting unit 2a.

The variable length code table selecting unit 2a performs a control operation to change the assignment of one of the variable length code tables 4 and 5 which is used for the above-mentioned decoding of the block data for each object to be shot in the above-mentioned block data. Concretely, the variable length code table selecting unit 2a carries out the following first through fifth selection processes, for example, so as to switch between the variable length code tables.

In the first selection process, the size of a motion vector provided to each macro block having, as a component, recoded block data and a threshold about the value of the DC component of the DCT coefficient in the block data (i.e., a threshold which is used when carrying out the recoding of the above-mentioned block data in the coded data recoding apparatus in accordance with above-mentioned embodiment 1) are set to the variable length code table selecting unit 2a in advance.

The sizes of motion vectors are grouped into a group in which the size of each motion vector is smaller than a threshold, and another group in which the size of each motion vector is equal to or larger than the threshold, and variable length code tables corresponding to the two groups are prepared in advance. The variable length code table selecting unit 2a determines a variable length code table which should be selected for the block data from the size of the motion vector inputted from the recoded data analyzing unit la and a result of comparison between the difference value between the DC component of a region specified by the block data to be processed and the DC component of another region surrounding the region, and the above-mentioned threshold.

In the case in which two or more thresholds are set to the recoding apparatus which has carried out the recoding of the above-mentioned block data, two or more thresholds are similarly set to the variable length code table selecting unit 2a. Code tables which are grouped according to the thresholds are prepared in advance. Even in this case, when the decoding of each block data which is grouped according to the two or more thresholds is carried out, the variable length code table selecting unit can select an appropriate code table.

Furthermore, the variable length code table selecting unit 2a is so constructed as to change the above-mentioned threshold dynamically, and to have code tables which are prepared for ranges having sizes which are varied with change in the threshold, respectively. As a result, the variable length code table selecting unit can select a code table which has been probably selected by the recoding apparatus by changing the threshold about motion vectors properly.

The second selection process is carried out in a case in which the recoding of the block data has been carried out by the recoding apparatus of above-mentioned embodiment 1 on the basis of the number of symbols and the code amount which has occurred in the actual coding processing, and in which the information showing the code table used for the recoding is included in the recoded moving image coded data.

In this case, the recoded data analyzing unit la extracts the information specifying the code table used for the recoding, which is provided as, for example, a part of the picture header, slice header, or macro block mode information of the recoded moving image coded data, or which is provided as the rectangle information in the screen 6 shown by FIG. 5 which is a unit, and outputs the extracted information to the variable length code table selecting unit 2a. The variable length code table selecting unit 2a selects the code table using the extracted information specifying the code table.

When selecting the variable length code table used for the recoding of the above-mentioned block data as mentioned above, the variable length code table selecting unit 2a outputs this selection result to the coded data reconstruction unit 15. The coded data reconstruction unit 15 then carries out the decoding process of decoding the above-mentioned block data using the selected variable length code table, and outputs the moving image coded data which comply with the standards of MPEG-2.

As mentioned above, the decoding apparatus in accordance with embodiment 3 is provided with the recoded data analyzing unit 1a for accepting a bit stream of coded data on a moving image in which block data have been recoded by the coded data recoding apparatus in accordance with above-mentioned embodiment 1, and analyzing the structure of the bit stream, and for extracting both the block data and data showing image characteristics, the variable length code tables 4 and 5 in which the amounts of codes which are assigned to symbols to be coded of the block data are optimized for each of the image characteristics, respectively, the code table selecting unit 2a for selecting a variable length code table used for the recoding on the basis of the data showing the image characteristics extracted by the recoded data analyzing unit 1a, and the coded data reconstruction unit 15 for decoding the block data using the variable length code table selected by the code table selecting unit 2a, and for outputting a bit stream of original coded data. Therefore, even if the accepted coded data are coded data in which symbols are respectively varied for subregions in images which construct the moving image and are recoded, the decoding apparatus can reconstruct the original coded data which comply with the MPEG-2 standards by decoding the block data which are coded data on each subregion.

### Embodiment 4

FIG. 8 is a block diagram showing the structure of a decoding apparatus in accordance with embodiment 4 of the present invention, and shows a case in which the decoding apparatus decodes moving image coded data in which the constitution data of slice headers or macro blocks are recoded. The decoding apparatus in accordance with this embodiment 4 is provided with a recoded data analyzing unit 1a, a coded data reverse conversion unit 16, a coded data reconstruction unit 15, an MAI data memory 9a, an MB type data memory 10a, a DCT type data memory 11a, a quantization parameter data memory 12a, a CBP data memory 13a, and a block data memory 14a.

The recoded data analyzing unit la analyzes moving image coded data which have been recoded by, for example, the coded data recoding apparatus in accordance with above-mentioned embodiment 1, and extracts recoded data to be decoded from the coded data. The coded data reconstruction unit 15 performs a decoding process on the coded data to be decoded which are inputted from the coded data reverse conversion unit 16.

In the following explanation, assume that the recoded data to be decoded have been recoded by the recoding apparatus in accordance with above-mentioned embodiment 2 through algebraic coding, instead of using a variable length code table. The coded data reverse conversion unit 16 carries out a process of adding the symbol which has been deleted from the recoded moving image coded data by the recoding apparatus in accordance with above-mentioned embodiment 2, or a reverse conversion process of replacing the symbol with an original symbol.

The MAI data memory 9a stores MAI data. The MB type data memory 10a stores macro block type data. The DCT type data memory 11a stores DCT block type data. The quantization parameter data memory 12a stores quantization parameter data. The CBP data memory 13a stores CBP data. The block data memory 14a stores block data.

The recoded data analyzing unit 1a, coded data reverse conversion unit 16, and coded data reconstruction unit 15, which are mentioned above, can be embodied by executing a decoding processing program in accordance with the present invention using, for example, a general-purpose computer.

An explanation of this embodiment will be made in more detail. The decoding processing program in accordance with the present invention is loaded into a computer and the operation of the coded data recoding program is controlled so that the coded data analyzing unit la, coded data reverse conversion unit 16, and coded data reconstruction unit 15 shown in FIG. 8 can be implemented in the computer. In this case, the memories 9a to 14a can be formed in a storage unit of the computer.

Because the structure and fundamental functions of a computer which embodies the decoding apparatus in accordance with the present invention can be recognized easily by those skilled in the art on the basis of the common general technical knowledge of the technical field of this invention, and are not directly in connection with the essence of the present invention, the detailed description of the structure and fundamental functions of a computer which embodies the decoding apparatus in accordance with the present invention will be omitted in the following explanation.

Next, the operation of the decoding apparatus in accordance with this embodiment of the present invention will be explained.

Hereinafter, a case in which the decoding apparatus reconstructs coded data in which various coded data which construct recoded moving image coded data (MAI data, macro block type data, DCT block type data, quantization parameter data, CBP data, and block data) are collectively recoded in predetermined units of, for example, pictures or slices will be explained as an example.

First, the recoded data analyzing unit la analyzes the structure of the moving image coded data which have been recoded by the recoding apparatus in accordance with above-mentioned embodiment 2, extracts one predetermined unit of the various coded data (e.g., a picture or slice of the various coded data), and stores the various coded data in the memories 9a to 14a, respectively.

When the recoded data analyzing unit completes storing all the coded data of one predetermined unit in the memories 9a to 14a, respectively, the coded data reconstruction unit 15 reads these data from the memories 9a to 14a, respectively, and outputs a bit stream which complies with the MPEG-2 standards so that it includes all the coded data which are arranged in a sequence according to the MPEG-2 standards.

As a result, the decoding apparatus can reconstruct an original bit stream from the moving image coded data in which the various coded data of one predetermined unit have been collectively recoded.

When the coded data reconstruction unit 15 reads the various coded data from the memories 9a to 14a, the coded data reverse conversion unit 16 determines whether the various coded data have been recoded through deletion or replacement of the symbol, and, when determining that deletion or replacement of the symbol has been performed, carries out a process of reconstructing this symbol.

For example, when accepting recoded coded data in which slice headers have been deleted by the recoding apparatus in accordance with above-mentioned embodiment 2, the coded data reverse conversion unit 16 inserts slice headers into predetermined units of the recoded coded data, respectively, and outputs the coded data to the coded data reconstruction unit 15 as a bit stream which complies with the MPEG-2 standards.

When accepting recoded coded data in which MAI data of I pictures have been all deleted by the recoding apparatus according o above-mentioned embodiment 2, the coded data reverse conversion unit 16 inserts MAI data into macro blocks of the recoded coded data, and outputs the coded data to the coded data reconstruction unit 15 as a bit stream which complies with the MPEG-2 standards.

A regular value about symbols of the various coded data, which comply with the MPEG-2 standards, is set to the coded data reverse conversion unit 16, and, in a case in which the various coded data to be decoded have been recoded through replacement of the symbol with another symbol, the coded data reverse conversion unit carries out the reconstruction process of replacing the other symbol with the original symbol.

For example, when accepting recoded coded data in which a symbol of “01” of the symbols of the macro block type data of I pictures has been replaced by another symbol of “0”, the coded data reverse conversion unit 16 replaces the symbol of “0” of the symbols of the macro block type data with the symbol of “01”, and outputs the coded data to the coded data reconstruction unit 15 as a bit stream which complies with the MPEG-2 standards.

Similarly, even when accepting recoded coded data in which a symbol of other coded data has been replaced by another symbol, the coded data reverse conversion unit 16 determines that the replacement has been made by making a comparison with the regular value set thereto, and replaces the other symbol of the other coded data with the original symbol.

As mentioned above, the decoding apparatus in accordance with embodiment 4 is provided with the recoded data analyzing unit 1a for accepting a bit stream of coded data on a moving image in which constitution data are recoded, and analyzing the structure of the bit stream, and for extracting the constitution data of the coded data, the memories 9a to 14a for storing the constitution data of the coded data extracted by the recoded data analyzing unit 1a, respectively, the coded data reverse conversion unit 16 for determining whether a process of deleting data which are not used for a decoding process to be performed on the constitution data of the coded data and/or a process of replacing the constitution data of the coded data with digital data having a smaller amount of information has been performed on the constitution data of the coded data, and for, when determining that the above-mentioned deleting process or replacing process has been performed on the constitution data of the coded data, performing a conversion process on the constitution data to convert these data back to original data, and the coded data reconstruction unit 15 for reading the constitution data of the coded data from the memories 9a to 14a, respectively, and decoding the recoded constitution data, and for outputting a bit stream of the original coded data. Therefore, the decoding apparatus can reconstruct coded data which comply with the MPEG-2 standards from the accepted coded data by reconstructing deleted data or replacing a symbol with an original symbol, or by replacing various symbols which have been coded collectively with original symbols on a macro-block-by-macro-block basis.

Although the above-mentioned embodiments are explained assuming that the recoding and decoding apparatus use MPEG-2 as an image coding method, the recoding and decoding apparatus in accordance with the present invention can alternatively use another image coding method which provides a moving image having a similar structure, such as MPEG-1 or MPEG-4 of ISO/IEC, or H.261 or H.263 of ITU-T.

### INDUSTRIAL APPLICABILITY

As mentioned above, the coded data recoding apparatus in accordance with the present invention can carry out recoding of a moving image coded data efficiently because it recodes the moving image coded data according to the image characteristics of a subregion in images which constructs the moving image, the image characteristics being extracted from the coded data on the moving image, and can be suitably applied to image compression using a coding method, such as MPEG-2, MPEG-1, MPEG-4, or H.261 or H.263 of ITU-T.

1. A coded data recoding apparatus comprising:
a coded data analyzing unit for accepting a bit stream of coded data on a moving image and analyzing a structure of the bit stream, and for extracting both coded data on a subregion in images which constructs said moving image and data showing image characteristics of said subregion;
a code table group provided with a plurality of code tables in which code amounts of codes which are assigned to symbols to be coded in said subregion are optimized respectively for each of the image characteristics;
a code table selecting unit for selecting a code table which is used for recoding of the coded data in said subregion from said code table group on a basis of the data showing said image characteristics extracted by said coded data analyzing unit; and
a recoding unit for recoding the coded data in said subregion using the code table selected by said code table selecting unit, and for outputting a bit stream of coded data containing the data recoded thereby.

2. The coded data recoding apparatus according to claim 1, characterized in that the coded data analyzing unit extracts motion vector data about the subregion in images which constructs the moving image from the accepted bit stream of coded data, the code table group is provided with the plurality of code tables in which the code amounts of codes which are assigned to the symbols to be coded of coded data in said subregion are optimized respectively for each of the image characteristics specified by a size of said motion vector, and the code table selecting unit selects the code table which is used for the recoding of the coded data in said subregion from said code table group on a basis of the size of the motion vector extracted by said coded data analyzing unit.

3. The coded data recoding apparatus according to claim 1, characterized in that the coded data analyzing unit extracts dc-component data having a discrete cosine transform coefficient about the subregion in images which constructs the moving image from the accepted bit stream of coded data, the code table group is provided with the plurality of code tables in which the code amounts of codes which are assigned to the symbols to be coded of coded data in said subregion are optimized respectively for each of the image characteristics specified by said dc-component data, and the code table selecting unit selects the code table which is used for the recoding of the coded data in said subregion from said code table group on a basis of a size of the dc component extracted by said coded data analyzing unit.

4. The coded data recoding apparatus according to claim 1, characterized in that the recoding unit incorporates information specifying the code table selected by the code table selecting unit into a part of the bit stream of coded data containing the recoded data so as to output the information.

5. A coded data recoding apparatus comprising:
a coded data analyzing unit for accepting a bit stream of coded data on a moving image and analyzing a structure of the bit stream, and for extracting constitution data of the coded data from the bit stream;
a storage unit group provided with a plurality of storage units which store said constitution data of the coded data extracted by said coded data analyzing unit extracted, respectively;
a data conversion unit for performing a process of deleting data which are not used for a decoding process to be performed on said constitution data of the coded data and/or a process of converting said constitution data of the coded data into digital data having a smaller amount of information on said constitution data of the coded data; and
a recoding unit for reading each constitution data of said coded data from each storage unit of said storage unit group so as to recode data to be recoded, and for outputting a bit stream of coded data containing the data recoded thereby.

6. The coded data recoding apparatus according to claim 5, characterized in that when extracting each constitution data of the coded data, the coded data analyzing unit stores it in a storage unit corresponding to each constitution data of said storage unit group, and the recoding unit reads and recodes plural constitution data stored in each storage unit of said storage unit group at a time.

7. A decoding apparatus comprising:
a recoded data analyzing unit for accepting a bit stream of coded data on a moving image in which coded data on an image subregion which constructs said moving image are recoded by the coded data recoding apparatus according to claim 1, and analyzing a structure of the bit stream, and for extracting both recoded coded data on said subregion and data showing image characteristics of said subregion;
a code table group provided with a plurality of code tables in which code amounts of codes which are assigned to symbols to be coded in said subregion are optimized respectively for each of the image characteristics;
a code table selecting unit for selecting a code table which has been used for the recoding of the coded data in said subregion from said code table group on a basis of the data showing said image characteristics extracted by said recoded data analyzing unit; and
a decoding processing unit for decoding the coded data in said subregion using the code table selected by said code table selecting unit, and for outputting a bit stream of original coded data.

8. The decoding apparatus according to claim 7, characterized in that the recoded data analyzing unit extracts motion vector data about the subregion in images which constructs the moving image from the bit stream of decoded coded data, the code table group is provided with the plurality of code tables in which the code amounts of codes which are assigned to the symbols to be coded of coded data in said subregion are optimized respectively for each of the image characteristics specified by a size of said motion vector, and the code table selecting unit selects the code table which has been used for the recoding of the coded data from said code table group on a basis of the size of the motion vector extracted by said recoded data analyzing unit.

9. The decoding apparatus according to claim 7, characterized in that the recoded data analyzing unit extracts dc-component data having a discrete cosine transform coefficient about the subregion in images which constructs the moving image from the bit stream of recoded coded data, the code table group is provided with the plurality of code tables in which the code amounts of codes which are assigned to the symbols to be coded of coded data in said subregion are optimized respectively for each of the image characteristics specified by said dc-component data, and the code table selecting unit selects the code table which has been used for the recoding of block data to be decoded from said code table group on a basis of a size of the dc component extracted by said recoded data analyzing unit.

10. The decoding apparatus according to claim 7, characterized in that in a case in which information specifying the code table which has been used for the recoding is included in the bit stream of recoded coded data, the recoded data analyzing unit extracts the information specifying the code table from the bit stream, and the code table selecting unit selects the code table which has been used for the decoding from the code table group on a basis of the information specifying said code table.

11. A decoding apparatus comprising:
a recoded data analyzing unit for accepting a bit stream of coded data on a moving image in which constitution data are recoded by the coded data recoding apparatus according to claim 5, and analyzing a structure of the bit stream, and for extracting the constitution data of said coded data;
a storage unit group provided with a plurality of storage units which store said constitution data of the coded data extracted by said coded data analyzing unit extracted, respectively;
a data reverse conversion unit for, when a process of deleting data which are not used for a decoding process to be performed on the constitution data of said coded data and/or a process of replacing the constitution data of said coded data with digital data having a smaller amount of information has been performed on the constitution data of said coded data by said coded data recoding apparatus, performing a conversion process on the constitution data to convert these data back to original data; and
a decoding processing unit for reading the constitution data of said coded data from the plurality of storage units of said storage unit group, respectively, and decoding the recoded constitution data, and for outputting a bit stream of original coded data.

12. A program which makes a computer function as:
a coded data analyzing unit for accepting a bit stream of coded data on a moving image and analyzing a structure of the bit stream, and for extracting both coded data on a subregion in images which constructs said moving image and data showing image characteristics of said subregion;
a code table group provided with a plurality of code tables in which code amounts of codes which are assigned to symbols to be coded in said subregion are optimized respectively for each of the image characteristics;
a code table selecting unit for selecting a code table which is used for recoding of the coded data in said subregion from said code table group on a basis of the data showing said image characteristics extracted by said coded data analyzing unit; and
a recoding unit for recoding the coded data in said subregion using the code table selected by said code table selecting unit, and for outputting a bit stream of coded data containing the data recoded thereby.

13. A program which makes a computer function as:
a coded data analyzing unit for accepting a bit stream of coded data on a moving image and analyzing a structure of the bit stream, and for extracting constitution data of the coded data from the bit stream;
a storage unit group provided with a plurality of storage units which store said constitution data of the coded data extracted by said coded data analyzing unit extracted, respectively;
a data conversion unit for performing a process of deleting data which are not used for a decoding process to be performed on said constitution data of the coded data and/or a process of replacing said constitution data of the coded data with digital data having a smaller amount of information on said constitution data of the coded data; and
a recoding unit for reading each constitution data of said coded data from each storage unit of said storage unit group so as to recode data to be recoded, and for outputting a bit stream of coded data containing the data recoded thereby.

14. A program which makes a computer function as:
a recoded data analyzing unit for accepting a bit stream of coded data on a moving image in which coded data on an image subregion which constructs said moving image are recoded by the coded data recoding apparatus according to claim 1, and analyzing a structure of the bit stream, and for extracting both recoded coded data on said subregion and data showing image characteristics of said subregion;
a code table group provided with a plurality of code tables in which code amounts of codes which are assigned to symbols to be coded in said subregion are optimized respectively for each of the image characteristics;
a code table selecting unit for selecting a code table which has been used for the recoding of the coded data in said subregion from said code table group on a basis of the data showing said image characteristics extracted by said recoded data analyzing unit; and
a decoding processing unit for decoding the coded data in said subregion using the code table selected by said code table selecting unit, and for outputting a bit stream of original coded data.

15. A program which makes a computer function as:
a recoded data analyzing unit for accepting a bit stream of coded data on a moving image in which constitution data are recoded by the coded data recoding apparatus according to claim 5, and analyzing a structure of the bit stream, and for extracting the constitution data of said coded data;
a storage unit group provided with a plurality of storage units which store said constitution data of the coded data extracted by said coded data analyzing unit extracted, respectively;
a data reverse conversion unit for, when a process of deleting data which are not used for a decoding process to be performed on the constitution data of said coded data and/or a process of replacing the constitution data of said coded data with digital data having a smaller amount of information has been performed on the constitution data of said coded data by said coded data recoding apparatus, performing a conversion process on the constitution data to convert these data back to original data; and
a decoding processing unit for reading the constitution data of said coded data from the plurality of storage units of said storage unit group, respectively, and decoding the recoded constitution data, and for outputting a bit stream of original coded data.
